(19) United States
(12) Patent Application Publication
(10) Pub. No.: US 2023/0419131 A1
(43) Pub. Date: Dec. 28, 2023

(54) SYSTEM AND METHOD FOR REDUCTION OF DATA TRANSMISSION IN DYNAMIC SYSTEMS THROUGH REVISION OF RECONSTRUCTED DATA

(71) Applicant: Dell Products L.P., Round Rock, TX (US)

(72) Inventors: Ofir Ezrielev, Be'er Sheva (IL); Jehuda Shemer, Kfar Saba (IL)

(21) Appl. No.: 17/850,754

(22) Filed: Jun. 27, 2022

(51) Int. Cl. G06N 5/04

(52) U.S. Cl. CPC G06N 5/04

(57) ABSTRACT

Methods and systems for managing data collection are disclosed. A data aggregator may aggregate data collected by a data collector. To reduce computing resources used for aggregation, the data aggregator and data collector may use inferences provided by a twin inference model in place of data collected by the data collector rather than receiving copies of data from the data collector. Over time, the aggregated data may be revised using revised inference models that are revised using subsequently obtained data from the data collector. The revised inference models may be used to obtain revised inferences that may replace original inferences in the aggregated data. The revised inferences may be of higher accuracy due to differences in the data upon which the inference and revised inference models are based.

### FIELD

Embodiments disclosed herein relate generally to data collection. More particularly, embodiments disclosed herein relate to systems and methods to limit resource consumption for the transmission of data during data collection.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show block diagrams illustrating a data aggregator and data collector over time in accordance with an embodiment.

FIG. 3A shows a flow diagram illustrating a method of aggregating data in a distributed system in accordance with an embodiment.

FIG. 3B shows a flow diagram illustrating a method of revising aggregated data in accordance with an embodiment.

FIGS. 4A-4C show diagrams illustrating a method of managing data aggregation over time in an industrial environment in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing data collection in a distributed system. To manage data collection, the system may include a data aggregator and a data collector. The data aggregator may aggregate data collected by the data collector. Aggregating the data at the data aggregator may consume computing resources due to, for example, transmission of the data across the distributed system.

To reduce the computing resources used to aggregate data, the data aggregator and data collector may implement a data reduction process to reduce the quantity of data transmitted for data aggregation purposes. The data reduction process may include implementing twin inference models at the aggregator and collector used to aggregate data at the data aggregator with inferences from the twin inference model rather than through transmission of data. The inference may include a degree of error due to limitations in the twin inference model.

After inferences are added to the aggregated data, the inferences may be revised to improve the accuracy of the aggregated data. For example, as additional data from a data collector becomes available, the twin inference model may be retrained, subjected to supplemental training, and/or new inference models may be generated and used to obtain revised inferences for the original inferences stored as part of the aggregated data. The original inferences may be replaced by the revised inferences. Doing so may improve the accuracy of the aggregated data because the revised inferences may be more accurate by virtue of the use of the subsequently obtained data for training purposes which may improve the inference accuracy of the revised inference models when compared to the original twin inference model.

Thus, embodiments disclosed herein may address the technical problem of computing resource cost for data aggregation. The disclosed embodiments may do so by aggregating data without requiring that all of the aggregated data be sent to an aggregation location. Consequently, the computing resource consumption load on the distributed system for aggregating data may be reduced. Accordingly, a distributed system in accordance with embodiments disclosed herein have more available computing resources for performing other tasks when compared with systems that do not implemented the disclosed embodiments while also providing for accuracy of the aggregated data through subsequent revision.

For system components that may be resource constrained, such as edge nodes, autonomous vehicles, etc., the improved availability of computing resources may enable these components to provide their other functions. Example embodiments are discussed below.

In an embodiment, a method for managing data collection in a distributed system where data is collected in a data aggregator of the distributed system and from a data collector of the distributed system that is operably connected to the data aggregator via a communication system is provided. The method may include obtaining, by the data aggregator, reduced size data from the data collector; obtaining, by the data aggregator using a local copy of a twin inference model, a locally generated inference duplicative of an inference upon which the reduced size data is based; obtaining, by the data aggregator, a representation of data upon which the reduced size data is based using: the reduced size data, and the locally generated inference; revising, by the data aggregator, the representation of the data using subsequently collected data from the data collector, the subsequently collected data being obtained via a transmission from the data collector in which the subsequent data is represented in a non-data reduced state due to the local copy of the twin inference model generating an inaccurate inference for the subsequently collected data; and performing an action set based on the revised reconstructed data.

Revising the representation of the data may include obtaining a data sample of the subsequently collected data; obtaining an updated inference model using the data sample, the updated inference model being based on the local copy of the twin inference model; obtaining a revised locally generated inference using the updated inference model; reconstructing a second representation of the data upon which the reduced size data is based using the reduced size data and the revised locally generated inference; and updating the representation of the data using the second representation of the data.

The local copy of the twin inference model may include a neural network. The updated inference model may be obtained by retraining the local copy of the twin inference model using the data sample.

The representation of the data may include a difference from the data upon which the reduced size data is based due to a level of inaccuracy of the locally generated inference.

The revised representation of the data may include a smaller difference from the data upon which the reduced size data is based due to a second level of inaccuracy of the revised locally generated inference being smaller than the level of inaccuracy of the locally generated inference.

The reduced size data indicates that the locally generated inference may be a sufficiently accurate representation of the data collected by the data collector such that no information regarding the data collected by the data collector will be transmitted to the data aggregator.

The reduced size data may be an absence of receipt of any information from the data collector regarding the data collected by the data collector.

The representation of the data upon which the reduced size data is based may be the locally generated inference.

The method may also include storing, by the data aggregator, the representation of the data upon which the reduced size data is based as validated data treated as a copy of data collected by the data collector; and replacing, by the data aggregator, the stored representation of the data upon which the reduced size data is based with the revised representation of the data.

A non-transitory media may include instructions that when executed by a processor cause the computer-implemented method to be performed.

A data processing system may include the non-transitory media and a processor, and may perform the computer-implemented method when the computer instructions are executed by the process.

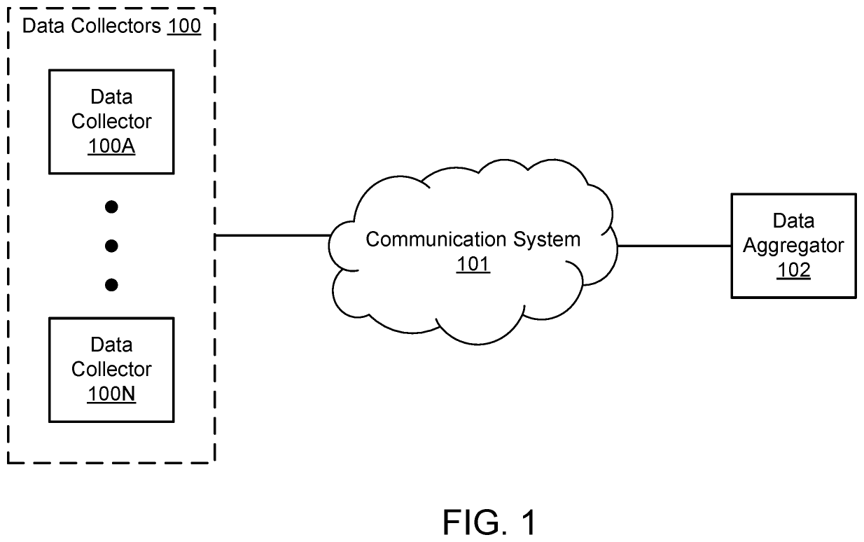

Turning to FIG. 1, a block diagram illustrating a system in accordance with an embodiment is shown. The system shown in FIG. 1 may provide computer-implemented services that may utilize data aggregated from various sources throughout a distributed system.

The system may include data aggregator 102. Data aggregator 102 may provide all, or a portion, of the computer-implemented services. For example, data aggregator 102 may provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed system.

For example, data aggregator 102 may be used as part of a control system in which data that may be obtained by data collectors 100 is used to make control decisions. Data such as temperatures, pressures, etc. may be collected by data collectors 100 and aggregated by data aggregator 102. Data aggregator 102 may make control decisions for systems using the aggregated data, and/or provide the aggregated data to other entities that may use the data for similar and/or different purposes. In an industrial environment, for example, data aggregator 102 may decide when to open and/or close valves using the aggregated data. Data aggregator 102 may be utilized in other types of environments and to make other types of control decisions (or other types of decisions entirely, or use the data for other purposes) without departing from embodiments disclosed herein.

To facilitate data collection, the system may include one or more data collectors 100. Data collectors 100 may include any number of data collectors (e.g., 100A-100N). For example, data collectors 100 may include one data collector (e.g., 100A) or multiple data collectors (e.g., 100A-100N) that may independently and/or cooperatively provide data collection services.

For example, all, or a portion, of data collectors 100 may provide data collection services to users and/or other computing devices operably connected to data collectors 100. The data collection services may include any type and quantity of services including, for example, temperature data collection, pH data collection, humidity data collection, etc. Different data collectors may provide similar and/or different data collection services.

To aggregate data from data collectors 100, some portion and/or representations of data collected by data collectors 100 may be transmitted across communication system 101 to data aggregator 102 (and/or other devices). The transmission of large quantities of data over communication system 101 may have undesirable effects on the communication system 101, data aggregator 102, and/or data collectors 100. For example, transmitting data across communication system 101 may consume network bandwidth and increase the energy consumption of data collectors 100.

In general, embodiments disclosed herein may provide methods, systems, and/or devices for managing data collection in a distributed system. To manage data collection in a distributed system, a system in accordance with an embodiment may limit the transmission of data between components of the system while ensuring that all components that need access to the data to provide their respective functions are likely to have access to accurate data. By limiting the transmission of data, communication bandwidth of the system of FIG. 1 may be preserved, energy consumption for data transmission may be reduced, etc.

To limit the transmission of data, data aggregator 102 may (i) implement a twin inference model system for data size reduction of data transmitted via communication system 101, and (ii) reconstruct the data that is size reduced. By doing so, data aggregator 102 may obtain an aggregation of data that is collected by data collectors 100 without needing to have copies of all of the data from the data collectors 100 sent to it or otherwise communicated.

To implement the twin inference model system, data aggregator 102 may generate (or otherwise obtain) and distribute inference models to one or more of the data collectors. Data aggregator 102 may attempt to predict data that may be obtained by data collectors 100 thereby reducing the need for data collected by the data collectors 100 to be transmitted to data aggregator 102 (e.g., the predictions may be used rather than obtained data, or sized reduced data representations such as differences between collected data and predictions of the collected data which may be used by the aggregator to reconstruct the collected data using a similar prediction that it generated). The representations may be implemented as statistics (e.g., statistical information regarding a portion of data obtained by a data collector), as differences (e.g., between data obtained by a data collector and a prediction for the collected data which may be generated locally or remotely), and/or other representations. In the case of differences, twin inferences models at data aggregator 102 and a collector may facilitate reconstruction of the data (or approximate reconstruction, with some error) at the aggregator with transmission of the difference (e.g., which may be highly compressible and/or otherwise require less data to represent) or other statistical representation. Transmission of data size reduced data of collected data may allow data aggregator 102 to provide its functionality (e.g., which may not require perfectly accurate data of that collected by data collectors 100) without needing to obtain full copies of all the collected data (e.g., from the data collectors).

To generate the predictions, data aggregator 102 and data collectors 100 may use inference models (copies of a same model hosted on both devices that generate the same predictions for collected data being referred to as “twin inference models”). The inference models may be implemented with, for example, trained machine learning models. The trained machine learning models may not be perfectly accurate thereby introducing error into data aggregated at data aggregator 102.

To improve the accuracy of aggregated data, data aggregator 102 may implement a revision process for data that has been obtained using inferences from the twin inference model. The revision process may include (i) obtaining copies of data (referred to as “subsequent data” or “subsequently collected data”)) from data aggregator 102 subsequent to when inferences from twin inference models are used to reconstruct some collected data based on obtained received size data, (ii) retraining copies of the twin inference model using the subsequent data, (iii) obtaining revised inferences using the copies of the retrained twin inference model, (iv) using the revised inferences to reconstruct the previously obtained data, and (v) replacing the previously obtained data in the aggregated data with the reconstructed previously obtained data. By utilizing the revised inferences to reconstruct the previously obtained data, the accuracy of the aggregated data may be improved.

For example, when an inference is used to reconstruct data obtained by a data collector, the reconstructed data may include some amount of error due to error present in the inference. Subsequently collected data may be used to retrain the inference model used to obtain the inference which may improve the accuracy of inferences generated by the inference model. The retrained inference model may then be used to obtain another copy of the previously used inference which now may include less error due to the larger data set used to train the retrained inference model. Consequently, when the other copy of the previously used inference is used to perform a similar retrospective reconstruction, the resulting reconstructed data may include less error due to the higher accuracy inference used in the reconstruction.

Data from a data collector may be reconstructed in different manners. For example, if an inference generated by an inference model is sufficiently accurate, the inference itself may be treated as a copy of data collected by a data collector. In this example, the data collector may not send any information or may sent an indication that a copy of the collected data may not be sent to cause the data aggregator to use (e.g., reconstruct) the inference as a copy of the collected data. In another example, the inference may be used in combination with some amount of data from the data collector to reconstruct data collected by the data collector. The data collector may, for example, send a quantized version of a difference between collected data an inference generated by a local copy of a twin inference model. When the difference is provided to the data aggregator, the data aggregator may use a copy of the inference (e.g., obtained via a second copy of the twin inference model that is local to the data aggregator) and the difference (e.g., a reduce data size representation of collected data) to reconstruct an approximate representation of the collected data.

In addition to collection of data through reconstruction, some full or complete copies of data collected by data collectors may be provided to data aggregator 102. For example, when a twin inference model generates inferences that are inaccurate beyond a threshold level of accuracy, data collectors 100 may provide data aggregator 102 with a copy of the data. These copies of the data (e.g., subsequent data) may be used, for example, to retrain copies of twin inference models usable to obtain revised reconstructions of the collected data.

By revising previously stored copies of data that include error due to the utilization of inferences, embodiments disclosed herein may provide a system that is better able to provide copies of more accurate data without increasing the quantity of computing resources expended for transferring data from data collectors to the data aggregator. Additionally, through this revision process, revised inference models may be used on a going forward basis so that future predictions used by the system will likely be more accurate.

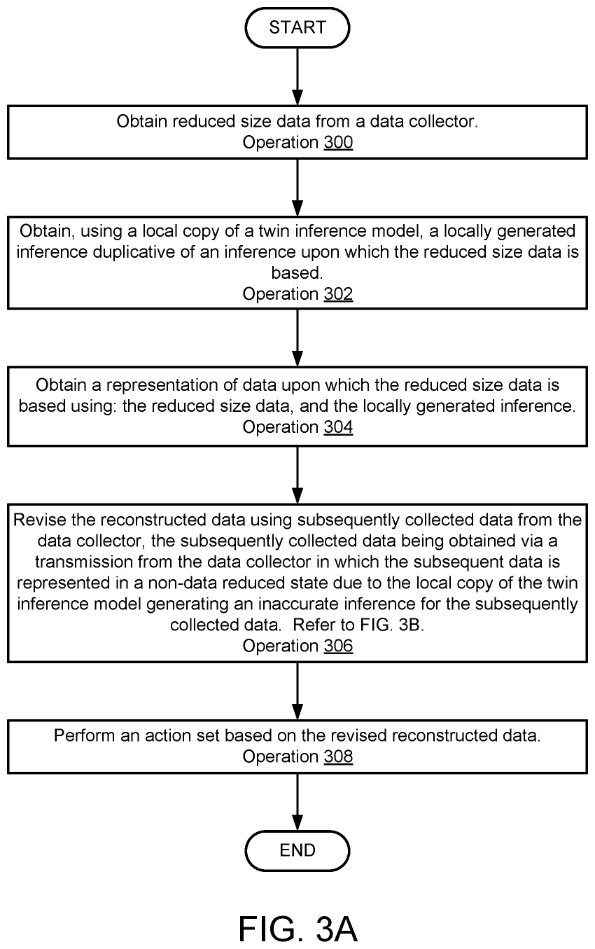

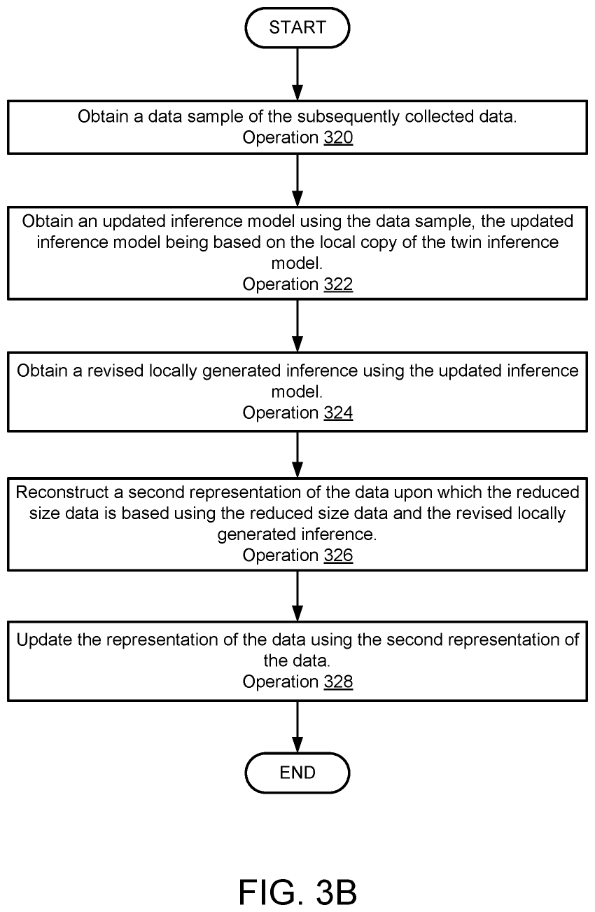

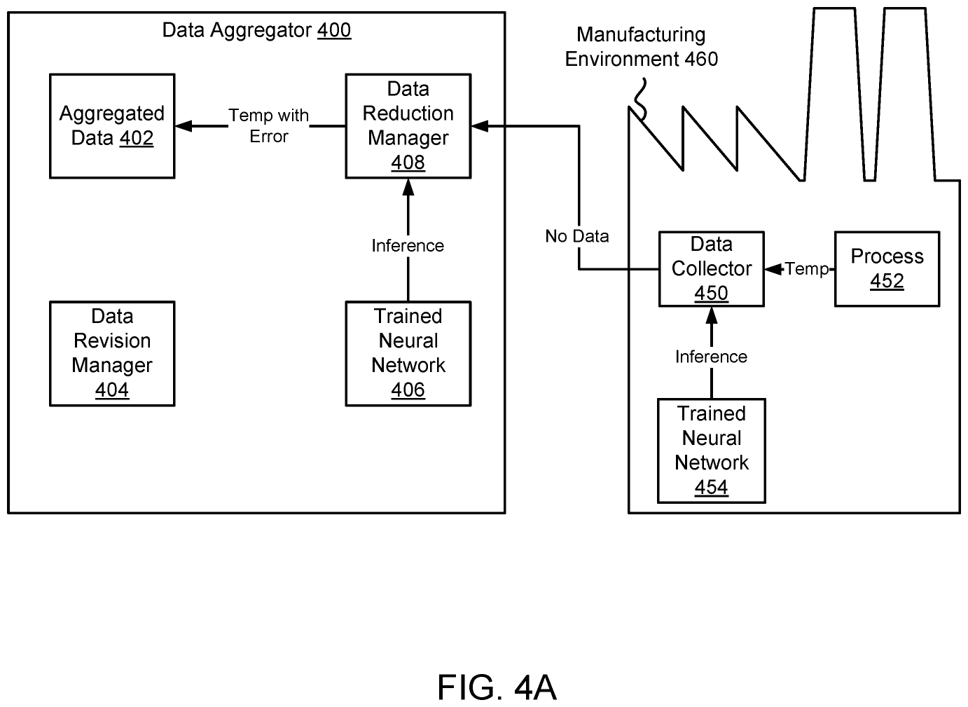

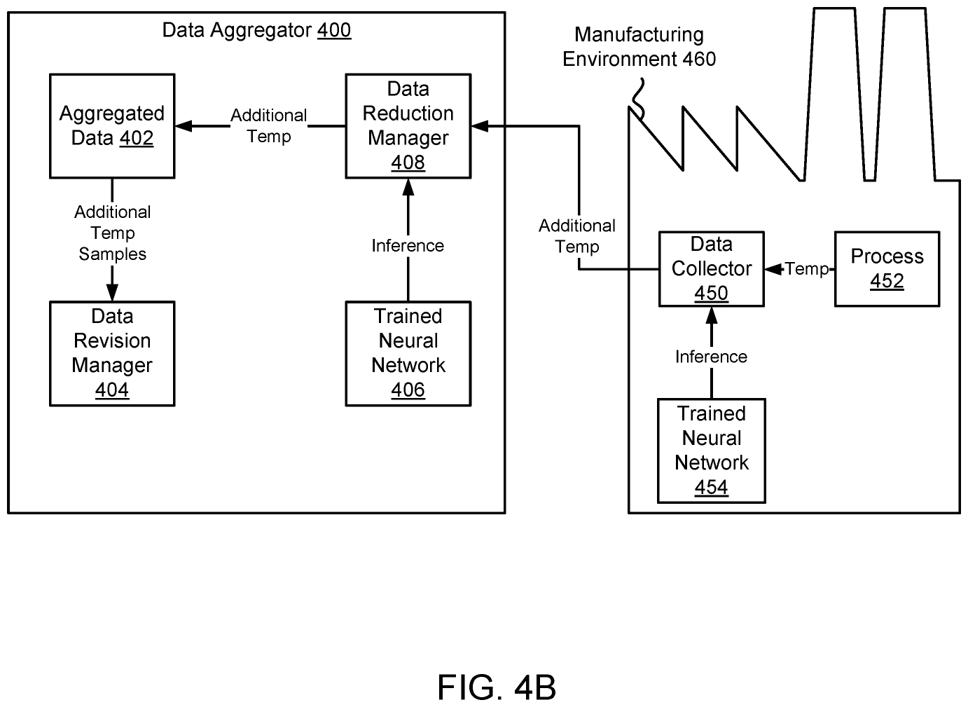

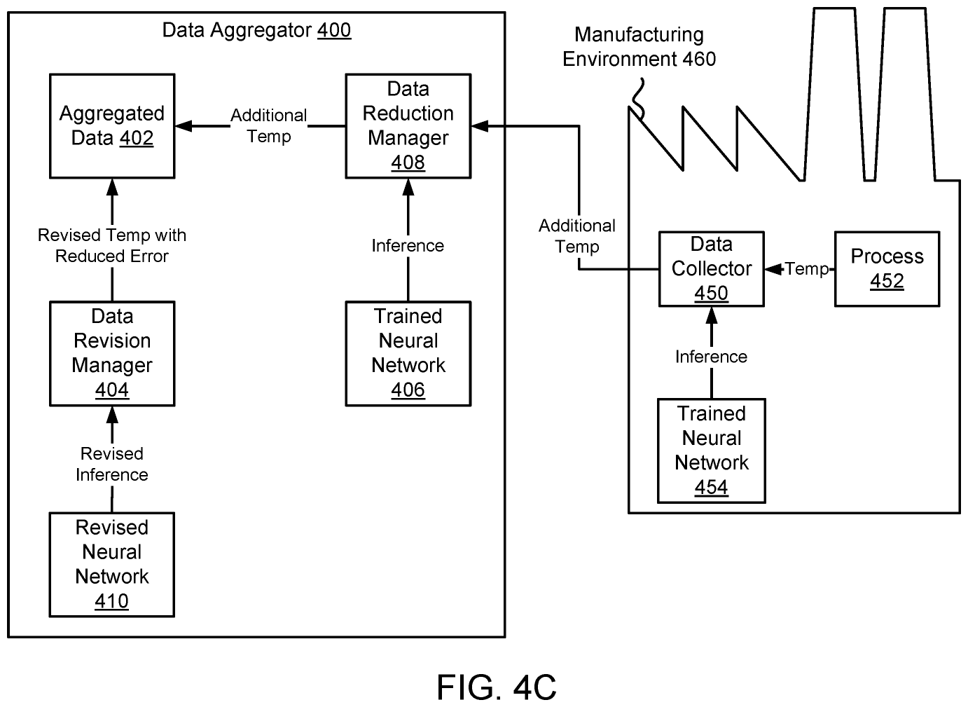

When performing its functionality, data aggregator 102 may perform all, or a portion, of the methods and/or actions shown in FIGS. 3A-4C.

Data collectors 100 may (i) collect data and (ii) implement data reduction to allow data aggregator 102 to aggregate the collected data. The data reduction may include one or more of: (i) not sending any information (e.g., a reduce data size representation of the data) when inferences for collected data are within a threshold level of accuracy, (ii) providing a difference or other type of derived information (e.g., a reduced data size representation of the data such as any type of statistic, such as a mean, median, etc.) when inferences for collected data exceed the threshold level of accuracy but do not exceed a second threshold for accuracy, and (iii) providing copies of collected data when inferences for collected data exceed the second threshold for accuracy.

When performing its functionality, data collectors 100 may perform all, or a portion, of the methods and/or actions shown in FIGS. 3A-4C.

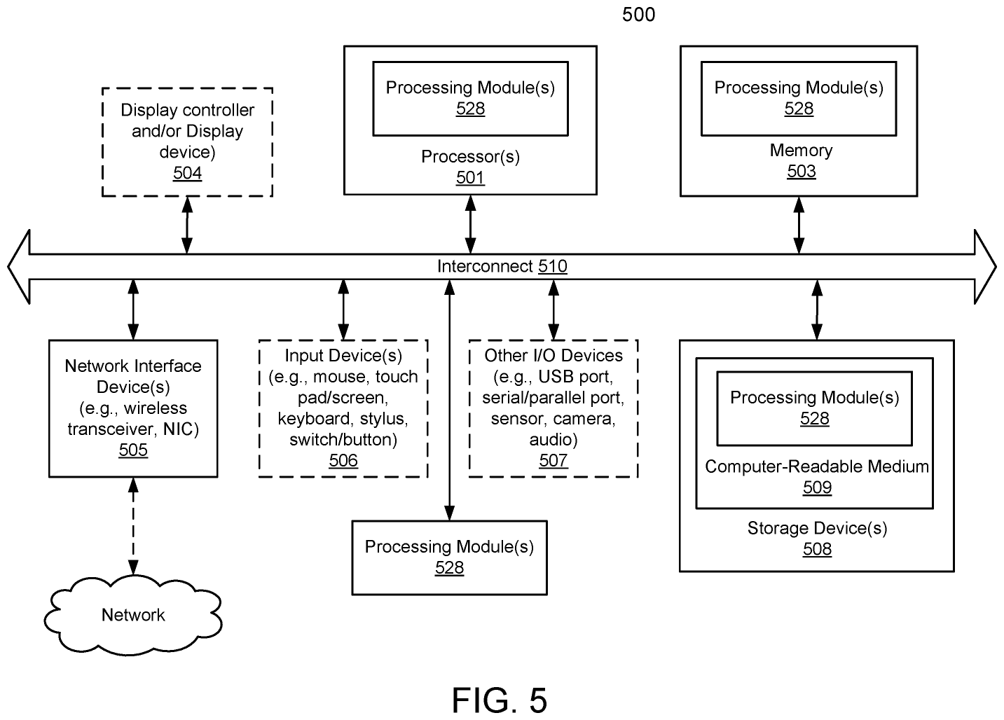

Any of data collectors 100 and/or data aggregator 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data collectors 100 are implemented using an internet of things (IoT) device, which may include a computing device. The IoT device may operate in accordance with a communication model and/or management model known to the data aggregator 102, other data collectors, and/or other devices.

In an embodiment, one or more of data collectors 100 are implemented using resource limited devices such as autonomous vehicles (e.g., drones, nanobots, etc.). These devices may have both computational and power limits thereby limiting the quantity of data that the devices may communicate.

Any of the components illustrated in FIG. 1 may be operably connected to each other (and/or components not illustrated) with a communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

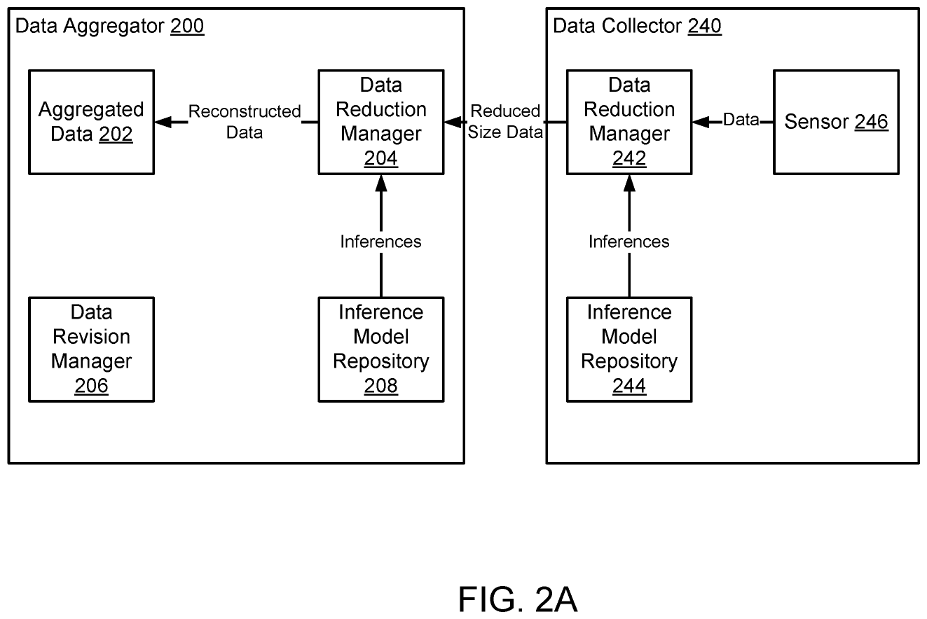

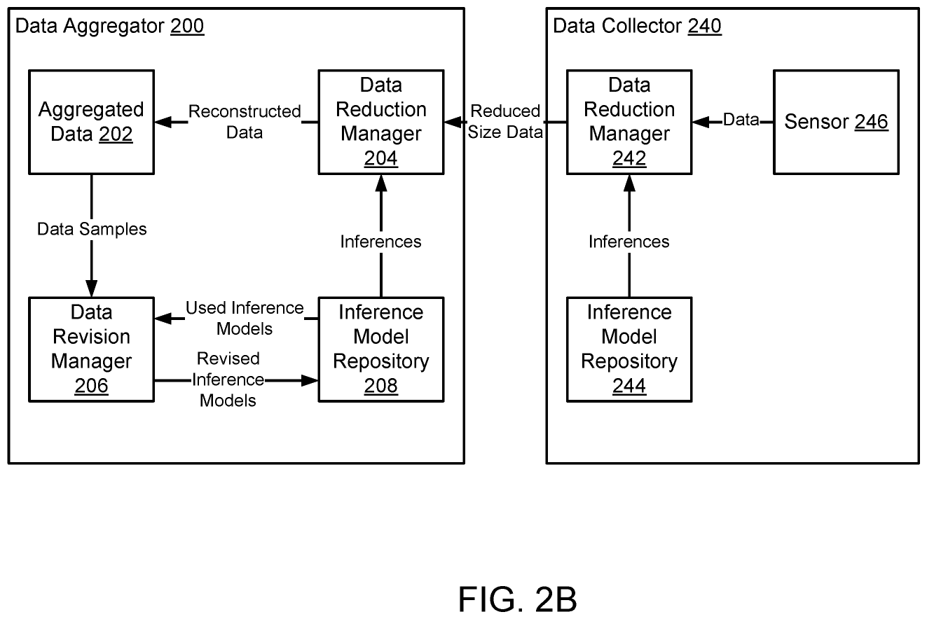

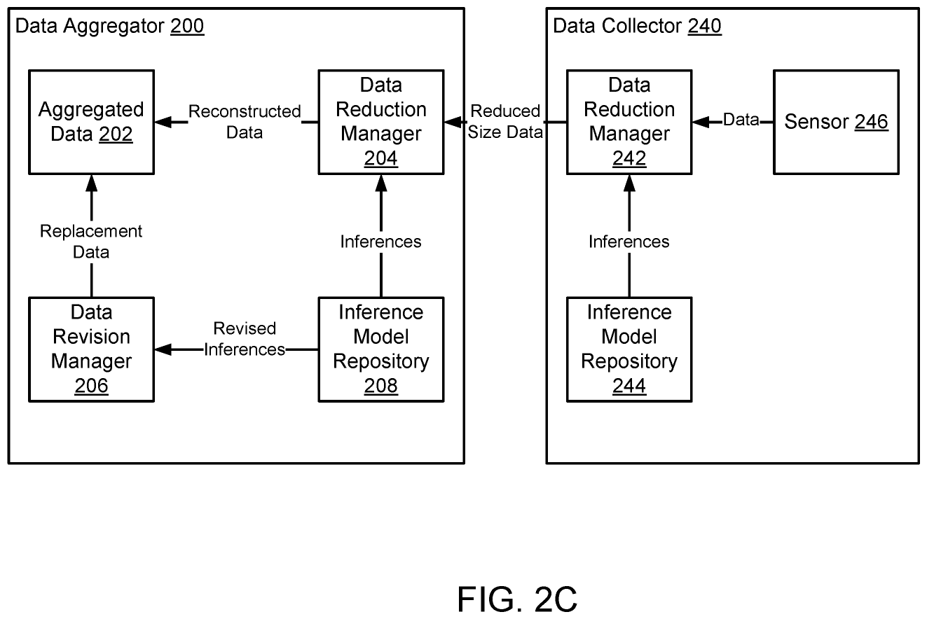

To further clarify embodiments disclosed herein, diagrams of a system over time in accordance with an embodiment are shown in FIGS. 2A-2C.

Turning to FIG. 2A, a diagram of data aggregator 200 and data collector 240 in accordance with an embodiment is shown. Data aggregator 200 may be similar to data aggregator 102, and data collector 240 may be similar to any of data collectors 100. In FIG. 2A, data aggregator 200 and data collector 240 are connected to each other via a communication system (not shown). Communications between data aggregator 200 and data collector 240 are illustrated using lines terminating in arrows.

As discussed above, data aggregator 200 may obtain aggregated data 202 (while shown with respect to a single data collector, aggregated data 202 may include data from multiple data collectors). Aggregated data 202 may include data obtained from data collector 240, predictions (e.g., inference obtained from a twin inference model) of data collected by data collector 240 that is not obtained by data aggregator 200, and reconstruction of data collected by data collectors 240. Downstream consumers (e.g., applications) may utilize aggregated data 202 to provide any type and quantity of services. The quality of these services may depend, at least in part, on the accuracy of aggregated data 202. In other words, on how faithful of a representation portions of aggregated data 202 are with respect to corresponding portions of data collected by data collector 240.

To obtain aggregated data 202, data aggregator 200 may host a data reduction manager 204. Data collector 240 may host a complementary data reduction manager 242. These data reduction managers 204, 242 may facilitate data collection in a manner that reduces the quantity of data transmitted between data aggregator 200 and data collector 240. For example, data reduction manager 242 may transmit reduced size representations of data collected by data collector 240 generated using a twin inference model from inference model repository 244. The reduced size data may, for example, not include any information (or may not be sent at all) when an inference from the twin inference model sufficiently accurately matches collected data, or a difference or other characterization when the inference less accurately matches the collected data.

Data reduction manager 204 may use the reduced size representations to reconstruct (perfectly or imperfectly) the data collected by data collector 240 using its copy of the twin inference model. Data reduction manager 204 may store the reconstructed data (which may simply be inferences, data derived from inferences, and/or actual copies of collected data) as aggregated data 202. Aggregated data 202 may be treated by downstream consumers as though it matches the data collected by data collector 240 faithfully, even though there may be some degree of difference due to the use of inferences and reconstruction in its generation.

To provide their functionalities, the data reductions manager 204, 242 may include or use twin inference models, as noted above, which may be stored in inference model repositories 208, 244. The trained twin inference models may provide inferences (predictions of data collected by data collector 240) which may be used to reduce the quantity of data transmitted between data collector and data aggregator 200 through data reconstructions. For example, an inference generated by a local copy of the twin inference model hosted by data aggregator 200 may be used as a representation of data collected by data collector 240 thereby facilitating aggregation of a representation of the collected data without any data transmission between data collector 240 and data aggregator 200.

Sensor 246 may obtain information regarding a characteristic of an environment in which data collector 240 is positioned. Sensor 246 may obtain the information using any sensing modality and may be implemented with any type of sensor. Different sensors of data collector 240 may collect similar or different types of information, and may collect any quantity of information. Sensor 246 may encode the information in data, and provide the data to data reduction manager 242. Sensor 246 may be implemented with any type of hardware device for sensing. While data collector 240 is illustrated and described as utilizing sensor 246 to obtain the collected data, the collected data may be obtained by data collector 240 via other devices/processes without departing from embodiments disclosed herein.

To improve the accuracy of collected data, data revision manager 206 may revise the data of aggregated data 202. To do so, turning to FIG. 2B, data revision manager 206 may obtain data samples from aggregated data. The data samples may include information obtained subsequently to when inferences obtained via a twin inference model are stored as aggregated data 202. The inferences may include some amount of error due to limitations of the twin inference model.

Data revision manager 206 may obtain a copy of the used inference model(s) and modify them using the data samples, rerun them using the subsequently obtained information, or otherwise use the previously used inference model(s) in combination with the subsequently obtained information to revise the data of aggregated data 202. For example, the inference models may be retrained, retuned, or otherwise modified using the data samples thereby improving the accuracy of the inference models. If implemented with neural networks, the neural networks may be revised through an automated learning, reinforcing, or other processes that may utilize the data samples to expand the quantity of information used to train the used inference models, or the neural networks may be reran using the subsequently obtained data as input to obtain different output than previously obtained. Through this process, the inference accuracy of the revised inference models may be improved (e.g., increased) with respect to the inference accuracy of the used inference models.

Turning to FIG. 2C, the revised inference models may be used to obtain revised inference (e.g., for the inferences previously stored as aggregated data). The revised inferences may be used as replacement data for the corresponding original inferences stored as part of aggregated data 202.

Through this process, the accuracy of the representation of the collected data (e.g., aggregated data 202 in FIGS. 2A-2C) hosted by data aggregator 200 may be improved. The revision process may be used, for example, to initiate certain computer implemented services through the performance of action sets. For example, when aggregated data 202 is revised, action sets may be performed to initiate the performance of previously performed computer implemented services that may have used the original inferences or the performance of remedial computer implemented services that may address deficiencies the previously performed computer implemented services due to the error in the original inferences included in aggregated data 202.

In an embodiment, any of data reduction manager 204, data revision manager 206, and data reduction manager 242 is implemented using a processor adapted to execute computing code stored on a persistent storage that when executed by the processor performs the functionality of data reduction manager 204, data revision manager 206, and/or data reduction manager 242 discussed throughout this application. The processor may be a hardware processor including circuitry such as, for example, a central processing unit, a processing core, or a microcontroller. The processor may be other types of hardware devices for processing information without departing embodiment disclosed herein.

While illustrated in FIGS. 2A-2C with a limited number of specific components, a data aggregator and/or data collector may include additional, fewer, and/or different components without departing from embodiments disclosed herein.

As discussed above, the components of FIG. 1 may perform various methods to aggregate data from a distributed system. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of aggregating data in a distributed system in accordance with an embodiment is shown. The method may be performed by a data aggregator and/or data collector.

At operation 300, reduced size data for data collected from a data collector is obtained from the data collector. The reduced size data may be obtained by (i) receiving a data structure corresponding to the reduced size data (e.g., via a communication system) or (ii) not receiving any data structures from the data collector. If received, the data structure may include a difference, statistical characterization, or other type of information derived from data collected by the data collector. If not received, the aggregator may infer that a locally generated inference corresponding to the data collected by the collector is a sufficiently accurate representation of the collected data.

At operation 302, a locally generated inference duplicative of an inference upon which the reduced size data is based is obtained. The locally generated inference may be obtained by generating it using a copy of a twin inference model (a copy of which may be hosted/used by the data collector). While described as duplicative, the locally generated inference may have some level of difference to that used by the data collector. For example, depending on the computing resources available to the data collector and data aggregator, the twin inference model may be an imperfect twin where one of the two (hosted by the aggregator or collector) provides somewhat more accurate inferences at higher computational resource cost.

At operation 304, a representation of data upon which the reduced size data is based is obtained using the reduced size data and the locally generated inference. The representation may be obtained by: (i) using the locally generated inference as the representation of the data, (ii) performing one or more operations such as adding a difference included in the reduced size data to the locally generated inference, and/or (iii) performing other types of operations using the reduced size data and the locally generated inference.

The representation of the data may be stored as aggregated data. Consequently, the representation of the data may be treated as being a copy of the data (e.g., data collected by a data collector) even though it may differ from the data by some degree.

At operation 306, the reconstructed data is revised using subsequently collected data from the data collector. The subsequently collected data may be obtained via a transmission from the data collector in which the subsequent data is represented in a non-data reduced state. The subsequently collected data may be transmitted in the form due to the local copy of the twin inference model generating an inaccurate reference for the subsequently collected data. This difference may indicate to the data collector that a corresponding inference generated by the data aggregator may not accurately represent the subsequent data. Accordingly, the data collector may transmit the subsequent data in the non-data reduced state to ensure that an accurate representation of the subsequent data is obtained by the data aggregator. For example, a copy of the subsequent data may be transmitted rather than a data size reduced form of the subsequent data.

The reconstructed data may be revised by (i) revising an inference model from which an inference was obtained and used to obtain the reconstructed data, (ii) obtain a revised inference corresponding to the used inference, and (ii) using the revised inference to revise the reconstructed data. Refer to FIG. 3B for additional details regarding revision of the reconstructed data.

At operation 308, an action set based on the revised reconstructed data is performed. The action set may include any number of actions which may, for example, cause computer implemented services provided using the reconstructed data to be provided again, cause other computer implemented services to be provided using the revised reconstructed data to address potential issue introduced through the use of the reconstructed data, and/or may cause other type of computer implemented services to be provided using the revised reconstructed data.

The method may end following operation 308.

Using the method illustrated in FIG. 3A, embodiments disclosed herein may provide for the revision of previously reconstructed data thereby improving the accuracy of aggregated data. The improved accuracy of the aggregated data may improve the quality of computer implemented services provided using the aggregated data.

Turning to FIG. 3B, a flow diagram illustrating a method of revising reconstructed data in accordance with an embodiment is shown. The method may be performed by a data aggregator and/or data collector.

At operation 320, a data sample of the subsequently collected data is obtained. The data sample may be obtained by reading a portion of the subsequently collected data from aggregated data. The portion may be selected to improve a diversity of data used to train inference models. For example, the range over which previously used training data ranges may be taken into account when selecting the portion of the subsequently collected data (e.g., may attempt to select the portion to broaden the range). Other considerations regarding the quality of the training data used to train twin inference models may be taken into account when selecting the portion of the subsequently collected data.

At operation 322, an updated inference model is obtained using the data sample. The updated inference model may be based on the local copy of the twin inference model. The updated inference model may be obtained by retraining (performing supplementary training) a copy of the local copy of the twin inference model using the data sample. By doing so, the newly trained twin inference model may provide more accurate inferences over a wider range when compared to the local copy of the twin inference model.

At operation 324, a revised locally generated inference is obtained using the updated inference model. The updated inference model may provide the locally generated inference (e.g., by providing the same input as provided to the local copy of the twin inference model used to obtain the original inference). The revised locally generated inference may be more accurate due to the improved inference generation capability of the updated inference model.

At operation 326, a second representation of the data upon which the reduced size data is based is reconstructed using the reduced size data and the revised locally generated inference. For example, in a scenario where the reduced size data included no data (e.g., indicating the original inference should be used as the representation of the data upon which the reduced size data is based) the revised locally generated inference may be used as the second representation. In other scenarios where the reduced size data included some data, the revised generated inference may be obtained by performing various operations (e.g., addition, multiplication, subtraction, etc.) using the reduced size data and the revised locally generated inference.

At operation 328, the representation of the data is updated using the second representation of the data. For example, the representation of the data in aggregated data may be replaced with the second representation.

The method may end following operation 328.

To further clarify embodiments disclosed herein, an example implementation in accordance with an embodiment is shown in FIGS. 4A-4C. These figures show diagrams illustrating a data aggregation process to support a manufacturing environment in accordance with an embodiment are shown. FIGS. 4A-4C may show examples of processes for aggregating data to drive the manufacturing environment in accordance with an embodiment.

Turning to FIG. 4A, consider a scenario in which data collector 450 is tasked with collecting data from process 452 being performing in manufacturing environment 460 in which products are manufactured that are constructed through heating a material to a particular level. The measured temperature may be used to calculate a yield estimate for the process. To monitor the process, data collector 450 may collect temperature data through the process.

To manage the manufacturing process, data aggregator 400 may be tasked with aggregating data from across manufacturing environment 460, including the temperature during the manufacturing process. The temperature data may be used to calculate process yield which may be used to manage future runs of the manufacturing process to hit production targets. Due to the large quantity of data needed to manage the manufacturing process, data aggregator 400 implements similar methods, as disclosed herein, to limit the quantity of data transmitted by data collector 450 (and other data collectors, not shown) to data aggregator 400.

To do so, data aggregator 400 provides a copy of a twin inference model (e.g., 406, 454) in the form of trained neural network 454 to data collector 450. Data collector 450 uses an inference from trained neural network 454 to ascertain that a temp measured for process 452 falls within a threshold. Consequently, data collector 450 sends no data to data reduction manager 408 regarding the temperature.

Because data reduction manager 408 does not receive any data regarding the temperature, data reduction manager 408 presumes that an inference from trained neural network 406 accurately represents the temperature. Accordingly, data reduction manager 408 stores the inference as the temper in aggregated data 402 even though the inference for the temper includes some error with respect to the temperature data collected by data collector.

Using the temperature data in aggregated data 402, an over-estimate of the process yield is produced which causes manufacturing environment 460 to reduce the next batch for process 452.

Turning to FIG. 4B, while preparing for the next batch, additional temperature data and corresponding inferences are obtained by data collector 450. In this instance, the inferences do not match the temperature data within the threshold. Consequently, data collector 450 sends additional temp data to data reduction manager 408 which stored the additional temp data in aggregated data 402.

The additional temperature data triggers data revision manager 404 to perform a revision process for the original inference for the first temperature data of aggregated data 402. To perform the revision process, data revision manager 404 obtains additional temperature samples from the newly added additional temperature data in aggregated data 402.

Turning to FIG. 4C, the additional temperature samples are used to supplement the training data used to train trained neural network 406 in training a revised neural network 410. Revised neural network 410 provides inferences with smaller levels of error when compared to trained neural network 406.

Using revised neural network 410, data revision manager 404 obtains a revised inference for the original inference. Data revision manager 404 uses the revised inference as a revised temperature and replaces the original inference in aggregated data 402 with the revised inference. Because the revised inference includes less error than that of the original inference, the revised inference more accurately represents the temperature measured by data collector 450.

The replacement of the original inference with the revised inference triggers data aggregator 400 to recalculate the yield for process 452. The revised inference indicates that a larger, more accurate representation of the yield than previously estimated will be provided by process 452. Consequently, manufacturing environment 460 increases a size of the next batch for process 452.

By doing so, manufacturing environment 460 may more accurately estimate its process yield resulting in a more efficient manufacturing process that is better able to meet production goals.

Any of the components illustrated in FIGS. 1-4C may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data collection in a distributed system where data is collected in a data aggregator of the distributed system and from a data collector of the distributed system that is operably connected to the data aggregator via a communication system, the method comprising:
obtaining, by the data aggregator, reduced size data from the data collector;
obtaining, by the data aggregator using a local copy of a twin inference model, a locally generated inference duplicative of an inference upon which the reduced size data is based;
obtaining, by the data aggregator, a representation of data upon which the reduced size data is based using:
the reduced size data, and
the locally generated inference;
revising, by the data aggregator, the representation of the data using subsequently collected data from the data collector, the subsequently collected data being obtained via a transmission from the data collector; and
performing an action set based on the revised reconstructed data.

2. The method of claim 1, wherein revising the representation of the data comprises:
obtaining a data sample of the subsequently collected data;
obtaining an updated inference model using the data sample, the updated inference model being based on the local copy of the twin inference model;
obtaining a revised locally generated inference using the updated inference model;
reconstructing a second representation of the data upon which the reduced size data is based using the reduced size data and the revised locally generated inference; and
updating the representation of the data using the second representation of the data.

3. The method of claim 2, wherein the local copy of the twin inference model comprises a neural network.

4. The method of claim 3, wherein the updated inference model is obtained by retraining the local copy of the twin inference model using the data sample.

5. The method of claim 2, wherein the representation of the data comprises a difference from the data upon which the reduced size data is based due to a level of inaccuracy of the locally generated inference.

6. The method of claim 5, wherein the revised representation of the data comprises a smaller difference from the data upon which the reduced size data is based due to a second level of inaccuracy of the revised locally generated inference being smaller than the level of inaccuracy of the locally generated inference.

7. The method of claim 1, wherein the reduced size data indicates that the locally generated inference is a sufficiently accurate representation of the data collected by the data collector such that no information regarding the data collected by the data collector will be transmitted to the data aggregator.

8. The method of claim 7, wherein the reduced size data is an absence of receipt of any information from the data collector regarding the data collected by the data collector.

9. The method of claim 7, wherein the representation of the data upon which the reduced size data is based is the locally generated inference.

10. The method of claim 9, further comprising:
storing, by the data aggregator, the representation of the data upon which the reduced size data is based as validated data treated as a copy of data collected by the data collector; and
replacing, by the data aggregator, the stored representation of the data upon which the reduced size data is based with the revised representation of the data.

11. A non-transitory machine-readable medium having instructions stored therein, which when executed by a processor, cause the processor to perform operations for managing data collection in a distributed system where data is collected in a data aggregator of the distributed system and from a data collector of the distributed system that is operably connected to the data aggregator via a communication system, the operations comprising:
obtaining, by the data aggregator, reduced size data from the data collector;
obtaining, by the data aggregator using a local copy of a twin inference model, a locally generated inference duplicative of an inference upon which the reduced size data is based;
obtaining, by the data aggregator, a representation of data upon which the reduced size data is based using:
the reduced size data, and
the locally generated inference;
revising, by the data aggregator, the representation of the data using subsequently collected data from the data collector, the subsequently collected data being obtained via a transmission from the data collector; and
performing an action set based on the revised reconstructed data.

12. The non-transitory machine-readable medium of claim 11, wherein revising the representation of the data comprises:
obtaining a data sample of the subsequently collected data;
obtaining an updated inference model using the data sample, the updated inference model being based on the local copy of the twin inference model;
obtaining a revised locally generated inference using the updated inference model;
reconstructing a second representation of the data upon which the reduced size data is based using the reduced size data and the revised locally generated inference; and
updating the representation of the data using the second representation of the data.

13. The non-transitory machine-readable medium of claim 12, wherein the local copy of the twin inference model comprises a neural network.

14. The non-transitory machine-readable medium of claim 13, wherein the updated inference model is obtained by retraining the local copy of the twin inference model using the data sample.

15. The non-transitory machine-readable medium of claim 11, wherein the representation of the data comprises a difference from the data upon which the reduced size data is based due to a level of inaccuracy of the locally generated inference.

16. A data aggregator, comprising:
a processor; and
a memory coupled to the processor to store instructions, which when executed by the processor, cause the processor to perform operations for managing data collection in a distributed system where data is collected in a data aggregator of the distributed system and from a data collector of the distributed system that is operably connected to the data aggregator via a communication system, the operations comprising:
obtaining, by the data aggregator, reduced size data from the data collector;
obtaining, by the data aggregator using a local copy of a twin inference model, a locally generated inference duplicative of an inference upon which the reduced size data is based;
obtaining, by the data aggregator, a representation of data upon which the reduced size data is based using:
the reduced size data, and
the locally generated inference;
revising, by the data aggregator, the representation of the data using subsequently collected data from the data collector, the subsequently collected data being obtained via a transmission from the data collector; and
performing an action set based on the revised reconstructed data.

17. The data aggregator of claim 16, wherein revising the representation of the data comprises:
obtaining a data sample of the subsequently collected data;
obtaining an updated inference model using the data sample, the updated inference model being based on the local copy of the twin inference model;
obtaining a revised locally generated inference using the updated inference model;
reconstructing a second representation of the data upon which the reduced size data is based using the reduced size data and the revised locally generated inference; and
updating the representation of the data using the second representation of the data.

18. The data aggregator of claim 17, wherein the local copy of the twin inference model comprises a neural network.

19. The data aggregator of claim 18, wherein the updated inference model is obtained by retraining the local copy of the twin inference model using the data sample.

20. The data aggregator of claim 16, wherein the representation of the data comprises a difference from the data upon which the reduced size data is based due to a level of inaccuracy of the locally generated inference.
